(19) United States
(12) Patent Application Publication
(10) Pub. No.: US 2019/0229484 A1
(43) Pub. Date: Jul. 25, 2019

(54) ELECTRICAL CONNECTOR AND METHOD OF ASSEMBLING THE SAME

(71) Applicant: Amphenol FCI Connectors Singapore Pte. Ltd., Singapore (SG)

(72) Inventors: Liaoju Cen, Dongguan (CN); Jun Chen, Dongguan (CN); Lu Song, Dongguan (CN)

(73) Assignee: Amphenol FCI Connectors Singapore Pte. Ltd., Singapore (SG)

(21) Appl. No.: 16/336,355

(22) PCT Filed: Oct. 3, 2017
(86) PCT No.: PCT/SG2017/050496

§ 371 Date: Mar. 25, 2019

(30) Foreign Application Priority Data
Oct. 4, 2016 (SG) 10201608298S

(51) Int. Cl. H01R 43/20; H01R 13/516

(52) U.S. Cl. CPC H01R 43/205; H01R 13/516

(57) ABSTRACT

An electrical connector comprises a housing and a terminal module. The housing has a top portion, a bottom portion and two side portions connecting the top portion and the bottom portion. The top portion, the bottom portion and the two side portions form an accommodating chamber and the terminal module is accommodated in the accommodating chamber. The two side portions have positioning posts preventing horizontal displacement of the housing relative to the terminal module, and the top portion and the bottom portion prevent vertical displacement of the housing relative to the terminal module. Methods of assembling the electrical connector are also provided.

### FIELD OF THE INVENTION

The present invention relates to an electrical connector, and particularly relates to a circuit board connector.

### BACKGROUND

Circuit board connectors are widely used in electrical apparatus for establishing electrical connection between circuit boards.

Traditional circuit connectors have the housings integrated with terminal modules thereof. It requires mounting the electrical connector as a whole to a printed circuit board. However, this requirement leads to mounting complexity in some applications. It is therefore desirable to improve the mounting process of circuit board connectors.

### SUMMARY

According to a first aspect, an electrical connector comprises a housing and a terminal module assembled to the housing. The housing has a top portion, a bottom portion and two side portions connecting the top portion and the bottom portion, the top portion, the bottom portion and the two side portions form an accommodating chamber and the terminal module is accommodated in the accommodating chamber. The two side portions have positioning posts extending downwardly for positioning and mounting the housing to a circuit board. The top portion and the bottom portion prevent vertical displacement of the housing relative to the terminal module.

In accordance with a second aspect, a method of assembling an electrical connector is provided. The electrical connector comprises a housing and a terminal module and the housing has an entrance and positioning posts. The method comprises fixing the terminal module to a printed circuit board; rotating the housing such that an effective height of the entrance is larger than a height of the terminal module; guiding the terminal module to enter an accommodating chamber of the housing through the entrance; and rotating the housing and inserting the positioning posts into corresponding holes of the printed circuit board.

In accordance with a third aspect, a method of assembling an electrical connector is provided. The electrical connector comprises a housing and a terminal module. The method comprises accommodating the terminal module partially in an accommodating chamber of the housing and angularly displacing the housing to accommodate the terminal module fully in an accommodating chamber of the housing.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with the present invention.

FIG. 1 is an exploded perspective view of an electrical connector in accordance with one embodiment.

FIG. 2 is a perspective view of the electrical connector of FIG. 1.

FIG. 3 is a perspective view of a housing of the electrical connector of FIG. 1.

FIG. 4 is a bottom perspective view of a housing of the electrical connector of FIG. 1.

FIG. 5 is a bottom perspective view of a housing of the electrical connector of FIG. 1.

FIG. 5A is a partial enlarged view of FIG. 5.

FIG. 6 is a side view of the electrical connector of FIG. 1.

FIG. 7 to FIG. 11 are cross section views of the assembling process of the electrical connector of FIG. 1.

FIG. 12 illustrates a method of assembling an electrical connector in accordance with one embodiment.

Skilled artisans will appreciate that elements in the figures are illustrated for simplicity and clarity and may necessarily be depicted to scale. For example, the dimensions of some of the elements may be exaggerated in respect to other elements to help improve understanding of the embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the present embodiment to provide an advantageous electrical connector that offers easy and reliable assembling as well as low defective rates and low manufacturing costs.

According to one embodiment of the invention, an electrical connector provided comprises a housing and a terminal module configured to be respectively assembled to a printed circuit board. The provided electrical connector decreases assembling complexity and enables separate removal and replacement of the housing, which thus reduces manufacturing costs and maintenance costs of clients products.

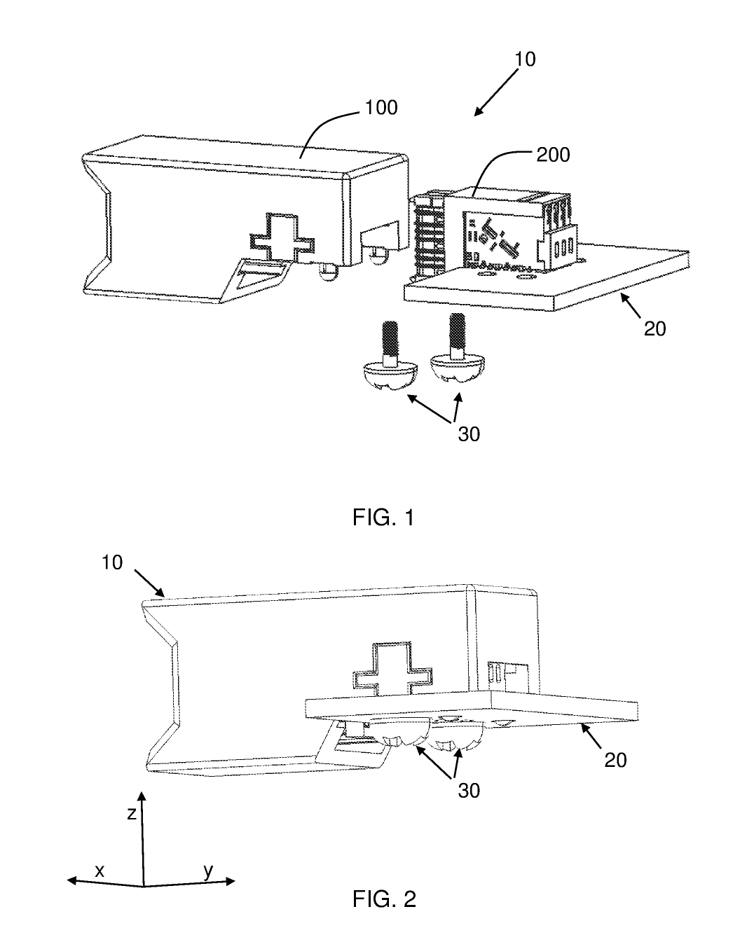

FIG. 1 is an exploded perspective view of an electrical connector 10 in accordance with one embodiment of the present invention. The electrical connector 10 comprises a housing 100 and a terminal module 200 that is to be mounted onto a printed circuit board 20 as shown in FIG. 1. In use, the housing 100 is also mounted to the printed circuit board 20, with terminal module 200 positioned in the housing 100, as shown in FIG. 2.

To assist clear understanding, an x-y-z axis system is shown in FIG. 2 with x axis parallel to a width direction of the connector 10, y axis parallel to a length direction of the connector 10 and z axis parallel to a height direction of the connector 10. Further, description of ‘left’ and ‘right’ in the context is intended to mean direction along the negative x axis and positive x axis, respectively; description of ‘top’ and ‘bottom’ is intended to mean direction along the positive z axis and negative z axis, respectively; description of ‘front and ‘back is intended to mean direction along the negative y axis and positive y axis, respectively.

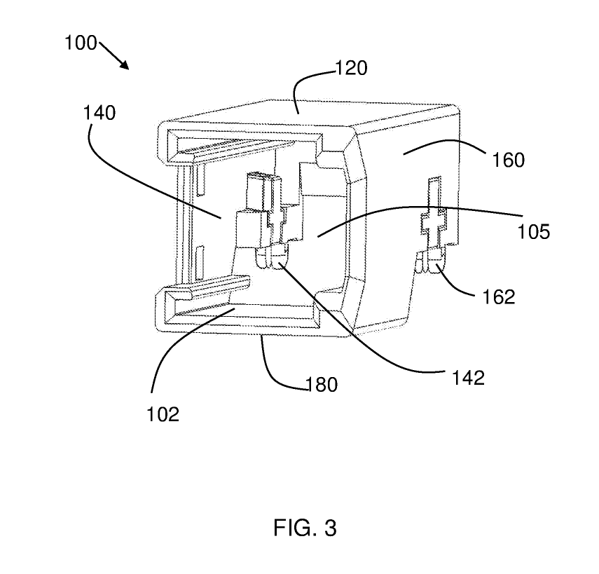

As shown in FIGS. 3 to 5, housing 100 has a top portion 120, a left portion 140, a right portion 160 and a bottom portion 180. The top portion 120 is connected respectively with top edges of the left portion 140 and the right portion 160, and the bottom portion 180 is connected respectively with bottom edges of the left portion 140 and the right portion 160. The top portion 120, the left portion 140, the right portion 160 and the bottom portion 180 form an accommodating chamber 105 having a front entrance 102 for receiving an counterpart connector for mating with the terminal module 200.

The left portion 140 and the right portion 160 may have notches at front ends thereof, respectively, assisting in receiving a counterpart connector to mate with the terminal module 200. The notches may have different shape and configuration, for example, square-shaped or trapezoid-shaped. Front ends of the top portion 120, the left portion 140, the right portion 160 and the bottom portion 180 may have tapered surfaces to guide terminals of a counterpart connector.

The bottom portion 180 of the housing 100 has a length shorter than the top portion 120 in the length direction of the housing 100 (i.e. the direction of y axis). A back edge 188 of the bottom portion 180, a back edge 148 of the left portion 140 and a back edge 168 of the right portion 160 form a chamfer 108.

A top back edge of the left portion 140 is connected with a top back edge of the right portion 160 through a downward-extending back portion 109. The housing 100 with a back portion 109 provides a higher structural strength and rigidity. The back portion 109 may have a notch at a bottom end thereof. The back portion 109 may also have a back chamfer 109a at a portion facing the accommodating chamber 105 of the housing 110.

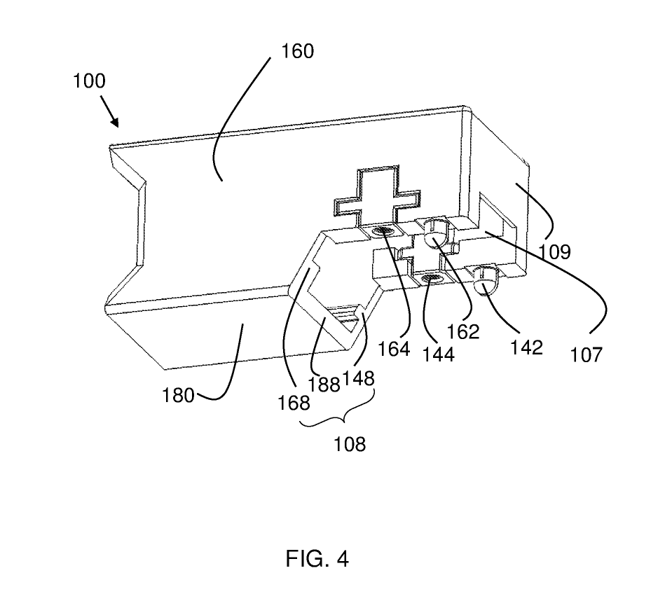

The left portion 140 and the right portion 160 have mounting surfaces between the chamfer 108 and the back portion 109 for engaging with a printed circuit board. The left portion 140 has a left positioning post 142 extending downwardly from the mounting surface thereof and a left mounting hole 144 for receiving a mounting screw. The left mounting hole 144 and the left positioning post 142 are aligned in a line parallel with the length direction of the housing 100. The right portion 160 has a right positioning post 162 extending downwardly from the mounting surface thereof and a right mounting hole 164 for receiving another mounting screw. The right mounting hole 164 and the right positioning post 162 are also aligned in a line parallel with the length direction of the housing 100. The left mounting hole 144 and the right mounting hole 164 may be formed on components separately formed from the housing 100, as shown in FIG. 4, and the components having the left mounting hole 144 and the right mounting hole 164 are embedded in corresponding cross shaped openings in the housing 100.

The chamfer 108, the mounting surfaces of the left portion 140 and the right portion 160 and the back chamfer 109a form a back entrance 107 into the chamber 105 of housing 100. During the process of mounting the electrical connector 10 to a printed circuit board, the terminal module 200 is firstly mounted to a printed circuit board, and then received and accommodated in the accommodating chamber 105 of housing 100, through the back entrance 107, and thereafter the housing 100 is mounted on the printed circuit board.

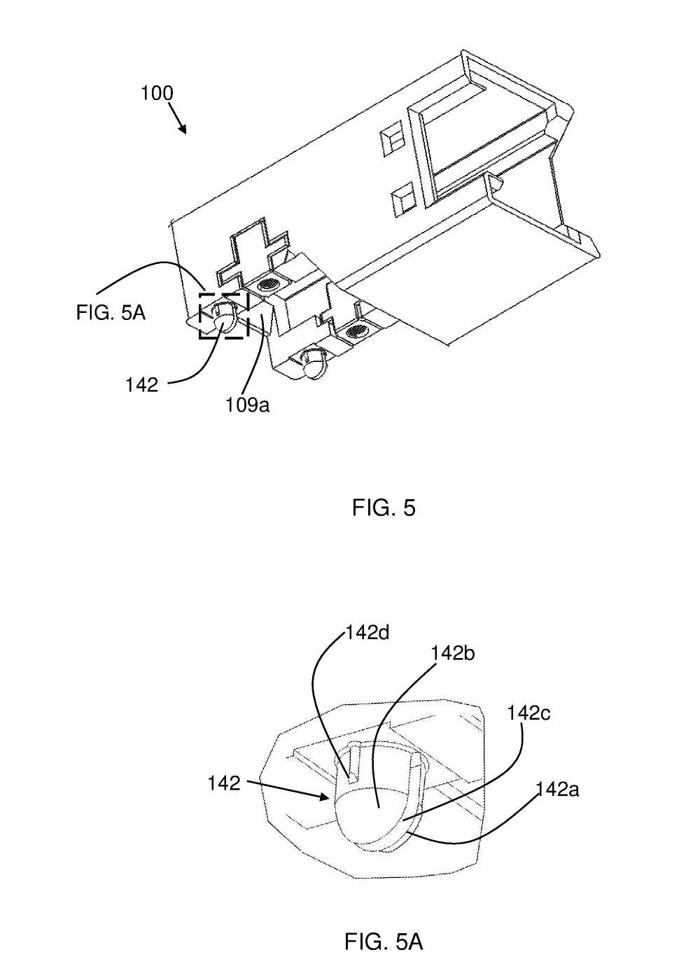

FIG. 5A is an enlarged perspective view of the positioning post 142. The positioning posts 142 and 162 have similar shape and dimension. Taking the positioning post 142 as an example, it is substantially cylindrical shaped having a spherical top end and two symmetrical halves 142a and 142b separated by a gap 142c. The two halves 142a and 142b each has a resilient piece 142d protruded from a side surface thereof.

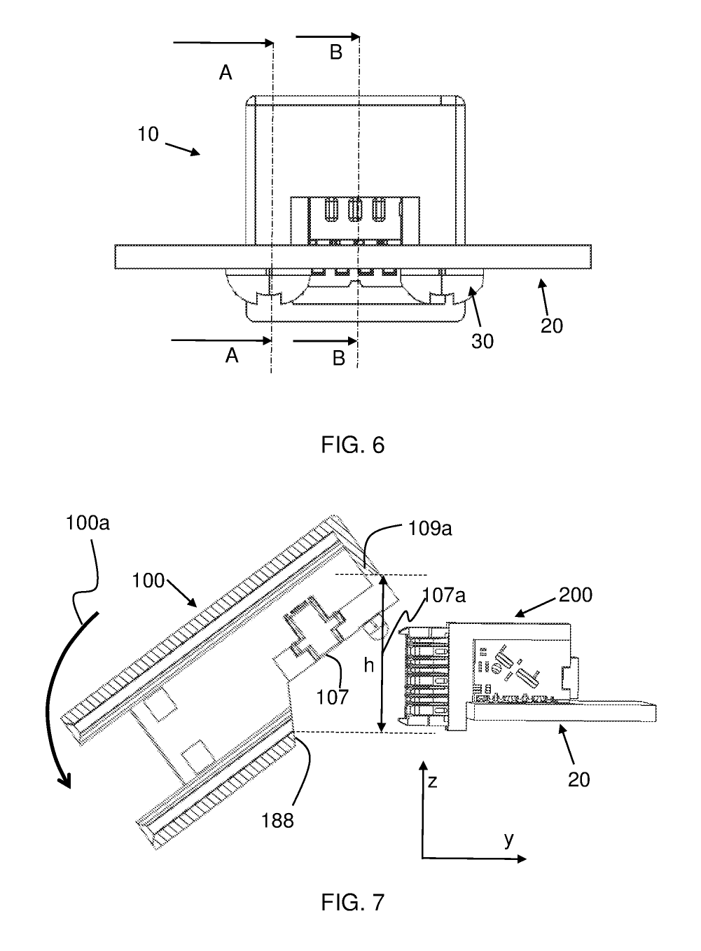

FIG. 6 is a rear view of the electrical connector 10. FIG. 7 to 11 are cross sectional views of the housing 110, terminal module 200 in a process of mounting to a printed circuit board. FIG. 7 to 9 are cross sectional views along line B-B in FIG. 6 and FIGS. 10 and 11 are cross section views along line A-A in FIG. 6.

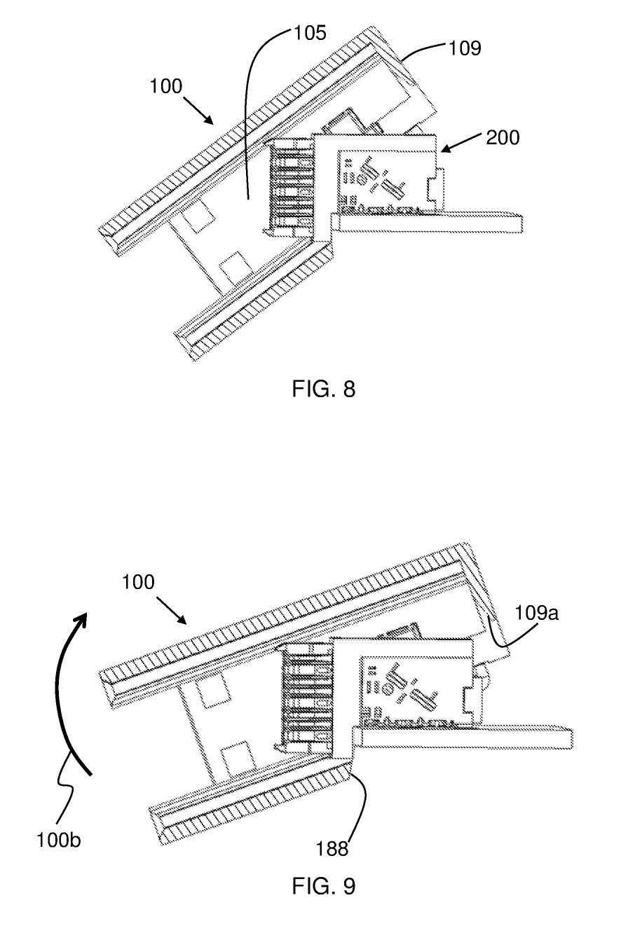

As shown in FIG. 7, in an assembling process, the housing 100 is rotated counterclockwise in the yz plane along a tilting direction 100a such that an effective height 107a (i.e. a projected height h of a distance from the back chamfer 109a of the back portion 109 to the back edge 188 of the back portion 180 in the z axis direction) of the back entrance 107 is larger than a height of the terminal module 200. Subsequently, as shown in FIG. 8, the housing 100 is moved toward the terminal module 200 such that the terminal module 200 enters the accommodating chamber 105 from the back entrance 107. After the terminal module 200 passes the back portion 109 of the housing 100, and taken the back edge 188 of the back portion 180 as a center as shown in FIG. 9, the housing 100 is rotated clockwise in the yz plane along an opposite direction 100b, to fully accommodate the terminal module 200. The back chamfer 109a permits passing of the terminal module 200 and accommodating of the terminal module 200 during assembling of the housing 100.

A height of the back portion 109 and a size of the back chamfer 109a can be predetermined according to the height and size of the terminal module 200, to enable assembly of the terminal module 200 and the housing 100 to a printed circuit board in the above-illustrated manner.

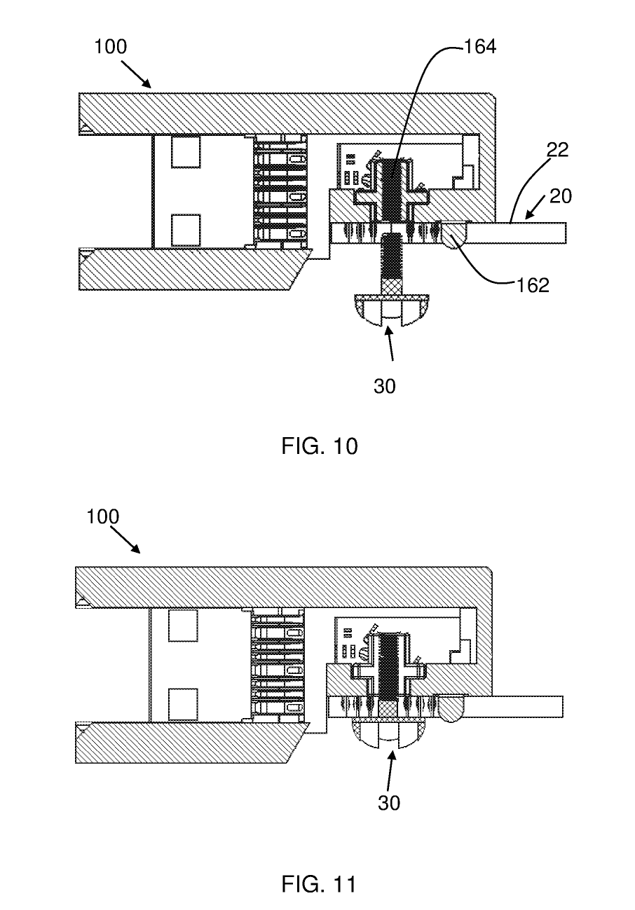

When the mounting surfaces of the left portion 140 and the right portion 160 abut against a mounting surface 22 of the printed circuit board 20, as seen in FIG. 10, the positioning posts 142 and 162 are inserted into corresponding holes of the printed circuit board 20 to position the housing 100. This makes accurate assembling position and prevents falling of the housing 100 during assembling. The spherical top ends make the positioning posts 142 and 146 easy insertion into the corresponding holes of the printed circuit board 20. Once the positioning posts 142 and 146 are inserted into the holes of the printed circuit board 20, the resilient pieces 142d and 146d are fastened in the holes to secure the housing 100 to the printed circuit board 20. Mounting screws are then fastened to the mounting holes 144, 146 through the printed circuit board 20, to fix the housing 10 to the printed circuit board 20.

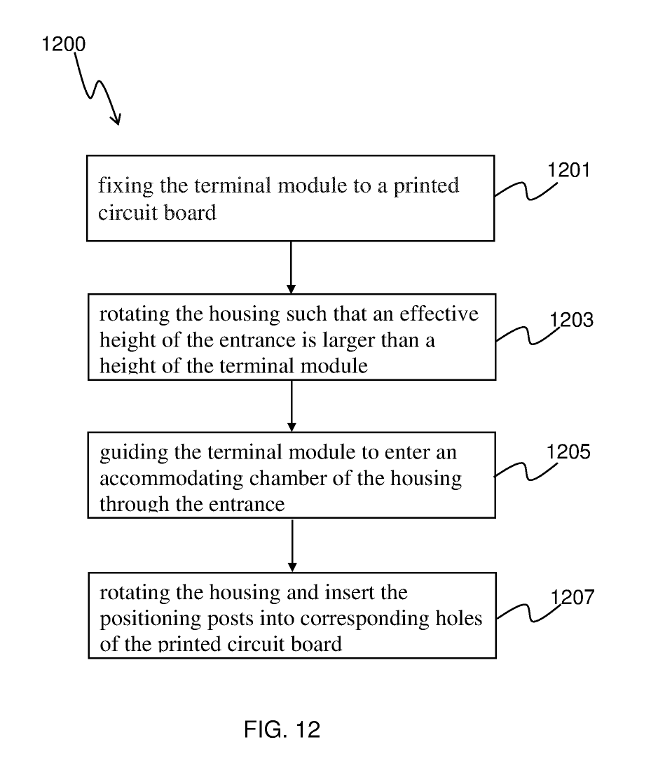

FIG. 12 illustrates a method 1200 of assembling an electrical connector in accordance with one embodiment. The electrical connector comprises a housing and a terminal module, the housing has an accommodating chamber and an entrance to the accommodating chamber, and positioning posts. At step 1201, the terminal module is fixed to a printed circuit board. At step 1203, the housing is rotated such that an effective height of the entrance is larger than a height of the terminal module. At step 1205, the terminal module is guided to enter the accommodating chamber of the housing through the entrance. At step 1207, the housing is reversely rotated and with the positioning posts inserted into corresponding holes of the printed circuit board.

While exemplary embodiments have been presented in the foregoing detailed description of the invention, it should be appreciated that a vast number of variations exist.

For example, housing 100 may be formed of any suitable material. In some embodiments, housing 100 may be formed of a conductive material, such as may result from folding a sheet of metal into walls bounding an accommodating portion. As another example, housing 100 may be partially or fully formed of a conductive material by die casting. In embodiments in which housing is fully or partially conductive, the conductive portions may be coupled to ground, either through attachment to printed circuit board 20 or through connections to grounded portions of terminal module 200. In other embodiments, housing 100 may be fully or partially insulating. In those embodiments, housing 100 may be formed by molding a thermoplastic material, for example. In embodiments in which housing 100 is partially insulating, the insulating portions may be positioned to align with signal terminals in terminal module 200.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

1. An electrical connector, comprising
a housing; and
a terminal module,
wherein the housing has a top portion, a bottom portion and two side portions connecting the top portion and the bottom portion, the top portion, the bottom portion and the two side portions form an accommodating chamber and the terminal module is accommodated in the accommodating chamber, and
wherein the two side portions have positioning posts preventing horizontal displacement of the housing relative to the terminal module, and the top portion and the bottom portion prevent vertical displacement of the housing relative to the terminal module.

2. The electrical connector according to claim 1, wherein the accommodating chamber has an entrance with a chamfer.

3. The electrical connector according to claim 1, wherein the accommodating chamber has an entrance with two chamfers.

4. The electrical connector according to claim 3, wherein the two chamfers are disposed at opposed position of the entrance.

5. The electrical connector according to claim 1, further comprises a back portion and an entrance is formed among the sides portions, the bottom portion and the back portion.

6. The electrical connector according to claim 5, wherein the back portion has a chamfer.

7. An electrical connector, comprising
a housing; and
a terminal module,
wherein the housing has a top portion, a bottom portion, and two side portions connecting the top portion and the bottom portion, the top portion, the bottom portion and the two side portions form an accommodating chamber and the terminal module is accommodated in the accommodating chamber, and
wherein the two side portions have positioning posts preventing horizontal displacement of the housing relative to the terminal module, and the top portion and the bottom portion prevent vertical displacement of the housing relative to the terminal module.

8. A method of assembling an electrical connector, wherein the electrical connector comprises a housing and a terminal module, the housing having an entrance and positioning posts, the method comprising:
fixing the terminal module to a printed circuit board;
rotating the housing such that an effective height of the entrance is larger than a height of the terminal module;
guiding the terminal module to enter an accommodating chamber of the housing through the entrance; and
rotating the housing and inserting the positioning posts into corresponding holes of the printed circuit board.

9. A method of assembling an electrical connector, wherein the electrical connector comprises a housing and a terminal module, the method comprising:
accommodating the terminal module partially in an accommodating chamber of the housing;
angularly displacing the housing to accommodate the terminal module fully in an accommodating chamber of the housing.
